(19) United States
(12) Patent Application Publication
(10) Pub. No.: US 2009/0299997 A1
(43) Pub. Date: Dec. 3, 2009

(54) GROUPING WORK SUPPORT PROCESSING METHOD AND APPARATUS

(75) Inventors: Kazunari TANAKA, Kawasaki (JP); Isamu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/356,811

(22) Filed: Jan. 21, 2009

(30) Foreign Application Priority Data
May 29, 2008 (JP) 2008-140291

(51) Int. Cl. G06F 7/00

(52) U.S. Cl. 707/5; 707/E17.067; 707/E17.138

(57) ABSTRACT

This method includes: extracting plural feature expressions from plural documents, and categorizing the extracted feature expressions into plural sets; presenting a user with one of the plural sets in a manner that the feature expressions included in the set can be recognized; accepting, from the user, a grouping instruction including designation of the feature expression to be unified among the feature expressions included in a specific set, and counting, as a first value, the number of documents including the feature expression to be unified, which is included in the grouping instruction; counting, as a second value, the number of documents including the feature expression included in a set that is other than the specific set and identified by a grouping mode and/or state; judging based on the first and second values whether a predetermined condition is satisfied; upon detecting that the predetermined condition is satisfied, notifying the user of the completion of designation of the feature expression to be unified.

### CROSS-REFERENCE TO RELATED APPLICATIONS

This application is based upon and claims the benefit of priority of the prior Japanese Patent Application No. 2008-140291, filed on May 29, 2008, the entire contents of which are incorporated herein by reference.

### FIELD

The embodiments discussed herein relate to a technique to support a grouping work to group different words and phrases into appropriate sets, when a user carries out the grouping work.

### BACKGROUND

For example, there is a case where the tendency of a set of technical documents such as patent documents or theses and/or questionnaire results is analyzed to obtain the knowledge from the analysis results. Especially, it has already been known that feature words and phrases (e.g. a control apparatus, low cost, and the like) representing, for example, an applicant, an object of the invention, a problem or the like are extracted from the patent documents to generate a graph and/or map by using the extracted words and phrases.

Even if the words and phrases are respectively different like “cost” and “low cost”, for example, there is a case where it is preferable to deal with both of them as a synonym. In such a case, it is necessary to group those words and phrases. However, there are some cases where it is preferable to deal with them as separate feature words and phrases, even if they are similar words and phrases. Therefore, it is difficult to automatically group all words and phrases, and in order to carry out an appropriate analysis, the human grouping work is required. Incidentally, some documents disclose techniques to support settings of the synonyms by using similarities between the feature words and phrases.

Moreover, the sets of grouped words and phrases are used when the graph and/or map are generated. However, for example, on the analysis of the tendency, the feature expression (i.e. word or phrase) whose number of documents including itself is large is important, and on the other hand, the feature expression whose number of documents including itself is several is not important on the analysis of the tendency. Namely, there is a case where the grouping work does not influence the analysis results, such as a case where the number of documents including that feature expression is already huge even if the grouping work is not carried out, or a case where the number of documents including that feature expression is too low to reach that of the higher-ranked expression, even if the grouping work would be carried out.

However, in the conventional arts, the user cannot know how much the grouping work should be carried out in order to carry out the appropriate analysis, and the user must carry out the grouping work, blindly, until he or she satisfies. Then, there is a case where the unnecessary grouping work that does not affect the analysis result is carried out, and it cannot be said that it is efficient.

### SUMMARY

Therefore, an object of embodiments is to provide a technique for causing the user to recognize the completion of the grouping work when the user carries out the grouping work.

This grouping work support processing method includes: extracting a plurality of feature expressions from a plurality of documents, and categorizing the extracted feature expressions into a plurality of sets; presenting a user with at least one of the plurality of sets in a manner that the feature expressions included in the set can be recognized; accepting, from the user, a grouping instruction including designation of the feature expression to be unified among the feature expressions included in a specific set, and counting, as a first value, the number of documents including the feature expression to be unified, which is designated in the grouping instruction, counting, as a second value, the number of documents including the feature expression included in a set that is other than the specific set and identified by at least one of a grouping mode and a grouping state; judging based on the first and second values whether or not a predetermined condition is satisfied; upon detecting that it is judged that the predetermined condition is satisfied, notifying the user of completion of designation of the feature expressions to be unified.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a functional block diagram of a grouping work support processing apparatus;

FIG. 2 is a diagram depicting an example of data stored in a document DB;

FIG. 3 is a diagram depicting an example of an association degree table;

FIG. 4 is a diagram depicting an example of a grouping candidate table;

FIG. 5 is a diagram depicting an example of a grouping completion flag table;

FIG. 6 is a diagram depicting an example of a tuning screen in a first embodiment;

FIG. 7 is a diagram depicting an entire processing flow executed by the grouping work support processing apparatus;

FIG. 8 is a diagram to explain an association degree calculation processing;

FIG. 9 is a diagram to explain the association degree calculation processing;

FIG. 10 is a diagram depicting a first portion of a processing flow of a grouping candidate generation processing;

FIG. 11 is a diagram depicting a second portion of the processing flow of the grouping candidate generation processing;

FIG. 12 is a diagram depicting a third portion of the processing flow of the grouping candidate generation processing;

FIG. 13 is a diagram depicting an example of the tuning screen in the first embodiment;

FIG. 14 is a diagram depicting an example of data stored in the document DB;

FIG. 15 is a diagram depicting a first portion of a processing flow of a grouping work support processing in the first embodiment;

FIG. 16 is a diagram depicting an example of the tuning screen in the first embodiment;

FIG. 17 is a diagram depicting an example of the grouping candidate table;

FIG. 18 is a diagram depicting a second portion of the processing flow of the grouping work support processing in the first embodiment;

FIG. 19 is a diagram depicting an example of the tuning screen in the first embodiment;

FIG. 20 is a diagram depicting the grouping candidate table;

FIG. 21 is a diagram depicting an example of the tuning screen in the first embodiment;

FIG. 22 is a diagram depicting an example of an analysis result screen;

FIG. 23 is a diagram depicting an example of the tuning screen in the first embodiment;

FIG. 24 is a diagram depicting an example of the tuning screen in the first embodiment;

FIG. 25 is a diagram depicting an example of the tuning screen in the first embodiment;

FIG. 26 is a diagram depicting an example of the tuning screen in a second embodiment;

FIG. 27 is a diagram depicting an example of the tuning screen in the second embodiment;

FIG. 28 is a diagram depicting a first portion of a processing flow of a grouping work support processing in the second embodiment;

FIG. 29 is a diagram depicting an example of the tuning screen in the second embodiment;

FIG. 30 is a diagram depicting an example of the grouping candidate table;

FIG. 31 is a diagram depicting a second portion of the processing flow of the grouping work support processing in the second embodiment;

FIG. 32 is a diagram depicting an example of the tuning screen in the second embodiment;

FIG. 33 is a diagram depicting an example of the grouping candidate table;

FIG. 34 is a diagram depicting an example of the tuning screen in the second embodiment; and

FIG. 35 is a functional block diagram of a computer.

### DESCRIPTION OF EMBODIMENTS

### Embodiment 1

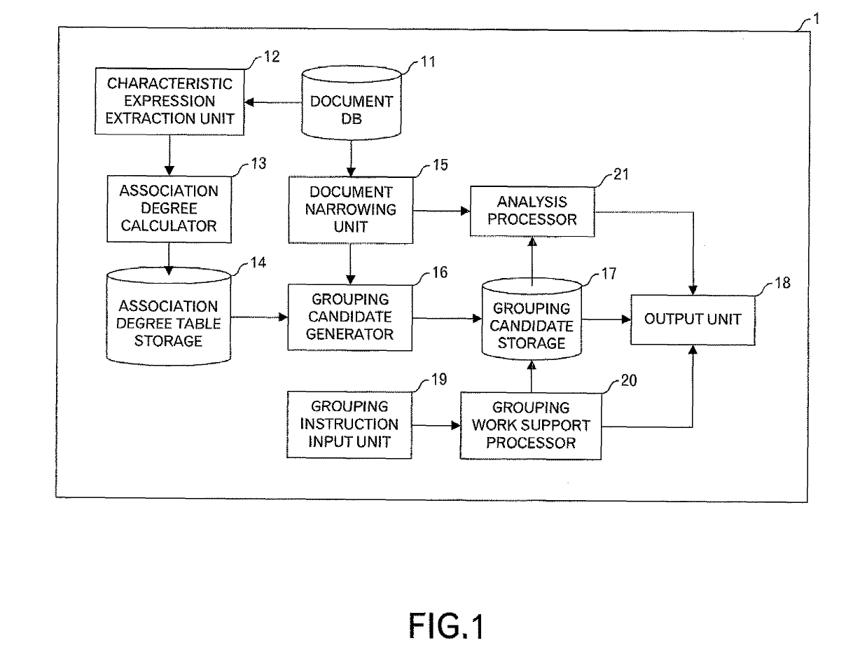

A first embodiment will be explained by using FIGS. 1 to 25. First, FIG. 1 depicts a functional block diagram of a grouping work support processing apparatus 1 relating to this embodiment. In an example of FIG. 1, the grouping work support processing apparatus 1 has a document DB storing document data to be analyzed such as patent documents; a feature expression extraction unit 12 that extracts feature expressions from the document DB 11; an association degree calculator 13 that calculates an association degree between the feature expressions based on the feature expressions extracted by the feature expression extraction unit 12, and generates an association degree table described later; an association degree table storage 14 that stores the association degree table generated by the association degree calculator 13; a document narrowing unit 15 that narrows document data stored in the document DB 11 based on a narrowing condition from a user; a grouping candidate generator 16 that generates a grouping candidate table described later based on the document data narrowed by the document narrowing unit 15 and the association degree table stored in the association table storage 14; a grouping candidate storage 17 storing the grouping candidate table generated by the grouping candidate generator 16 and a grouping completion flag table described later; an output unit 18 that outputs the grouping candidates, analysis results and the like based on data stored in the grouping candidate storage 17; a grouping instruction input unit 19 that accepts an input of a grouping instruction from the user; a grouping work support processor 20 that carries out a grouping work support processing described later based on the grouping instruction accepted by the grouping instruction input unit 19; and an analysis processor 21 that analyzes document data narrowed by the document narrowing unit 15 based on data stored in the grouping candidate storage 17.

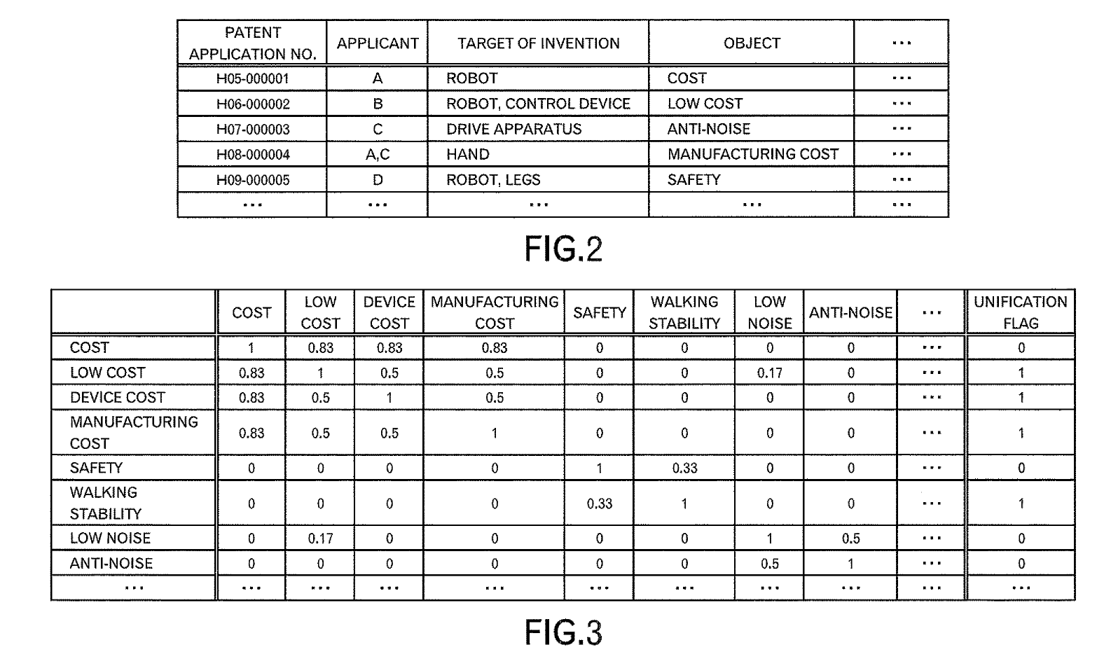

FIG. 2 depicts an example of data stored in the document DB 11. Incidentally, FIG. 2 depicts an example of data concerning the patent documents. In the example of FIG. 2, a table in the document DB 11 includes a column of an application number, a column of an applicant, a column of a target of an invention, a column of an object, and the like.

FIG. 3 depicts an association degree table stored in the association degree table storage 14. Incidentally, FIG. 3 depicts a case where “cost”, “low cost”, “device cost”, “manufacturing cost”, “safety”, “walking stability”, “low noise”, “anti-noise” and the like are extracted as a feature expression. In an example of FIG. 3, the association degree table includes a column of “cost”, a column of “low cost”, a column of “device cost”, a column of “manufacturing cost”, a column of “safety”, a column of “walking stability”, a column of “low noise”, a column of “anti-noise”, . . . , and a column of a unification flag. Moreover, the association degree table includes a line of “cost”, a line of “low cost”, a line of “device cost”, a line of “manufacturing cost”, a line of “safety”, a line of “walking stability”, a line of “low noise”, a line of “anti-noise”, and the like, and stores, for each combination, an association degree between a feature expression in the line and a feature in the column. Incidentally, a calculation processing of the association degree will be explained in details later. In addition, a flag representing whether or not the feature expression should be unified to another feature expression (“1” represents unified, and “0” represents not unified) is stored in the column of the unification flag.

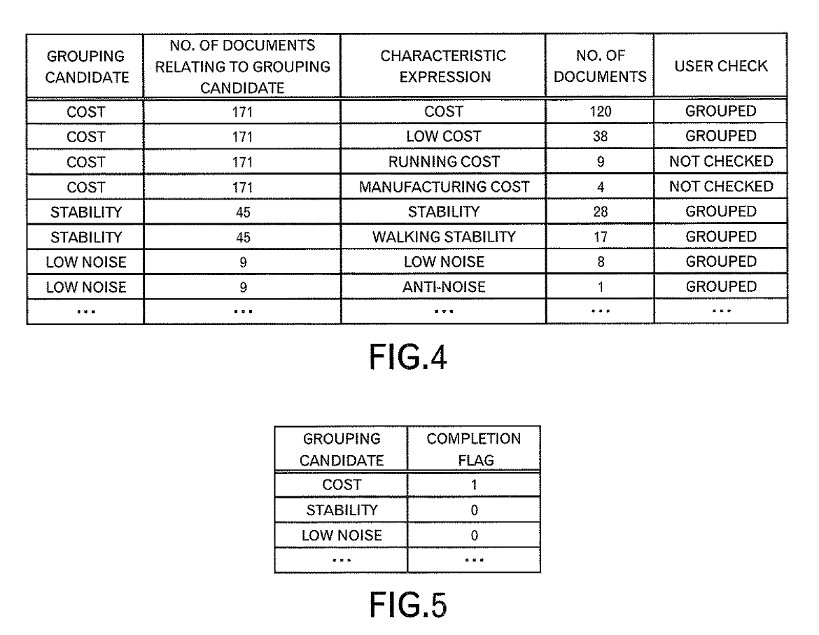

FIGS. 4 and 5 depict an example of tables stored in the grouping candidate storage 17. FIG. 4 depicts an example of the grouping candidate table. In the example of FIG. 4, the grouping candidate table includes a column of a grouping candidate, a column of the number of documents relating to the grouping candidate, a column of a feature expression, a column of the number of documents relating to the feature expression, and a column of a user check. The number of documents including the feature expression of the feature expression is registered into the column of the number of documents. A unification representative expression of the feature expression is registered into a column of the grouping candidate. For example, the example of FIG. 4 represents it is expected that “cost”, “low cost”, “running cost” and “manufacturing cost” are unified into “cost”. The total sum of the numbers of documents relating to the feature expressions, which have the same grouping candidate, is registered into the column of the number of documents relating to grouping candidate. For example, “cost” is registered in the columns of the number of documents relating to the grouping candidate for “cost”, “low cost”, “running cost” and “manufacturing cost”, and the total sum (120+38+9+4=0.71) of the numbers of documents for those lines is registered in the columns of the number of documents relating to the grouping candidate for those lines. In addition, information representing whether or not the feature expression is grouped is registered into the column of the user check. In FIG. 4, “grouping” in the column of the user check represents that the user instructs the feature expression should be unified. Moreover, “no grouping” in the column of the user check represents the user instructs the feature expression should not be unified. Furthermore, “not checked” in the column of the user check represents the user does not instructs whether or not the feature expression should be unified. Incidentally, the generation processing of the grouping candidate table will be explained in details later.

In addition, FIG. 5 depicts an example of the grouping completion flag table. In the example of FIG. 5, the grouping completion flag table includes a column of a grouping candidate and a column of the completion flag. A flag (“1” represents “completed” and “0” represents “not completed”) representing whether or not the grouping instruction for the grouping candidate has been made from the user is registered into the column of the completion flag. Incidentally, the setting of the completion flag will be explained in details later.

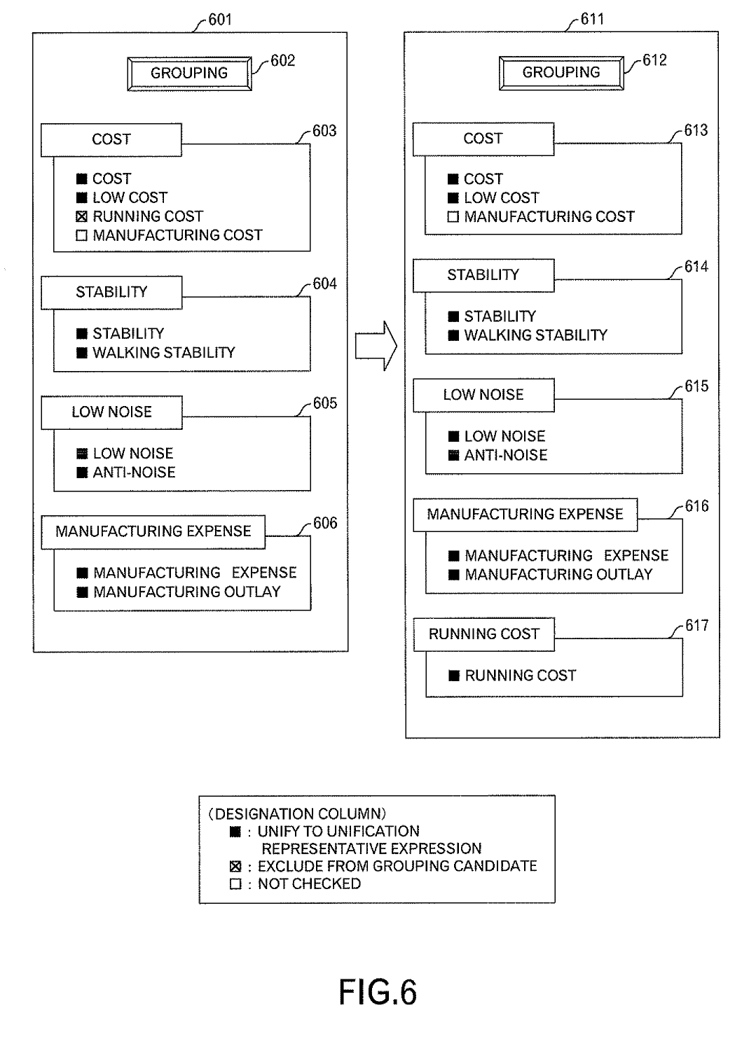

Before explaining a specific processing of the grouping work support processing apparatus 1 in this embodiment, an outline of this embodiment will be simply explained. For example, in this embodiment, the grouping work support processing apparatus 1 presents the user with a tuning screen 601 as depicted in the left of FIG. 6. In the example of FIG. 6, a grouping button 602 and selection columns (selection columns 603 to 606) of the respective grouping candidates are provided in the tuning screen 601. Furthermore, the unification representative expression (i.e. grouping candidate) and feature expressions relating to the grouping candidates are displayed in each selection column, and a designation column to designate whether or not the feature expression should be unified or whether or not the feature expression should be excluded from the grouping candidates is provided for each feature expression. Then, the user operates a keyboard and/or mouse to carry out the grouping work for each grouping candidate in this tuning screen 601. Namely, as the grouping work, the user designates whether or not the feature expression should be unified, or whether or not the feature expression should be excluded from the grouping candidates.

For example, in the tuning screen 601, designation that “running cost” should be excluded from the grouping candidate “cost” is made in the selection column 603, and when the grouping button 602 is clicked in such a state, a tuning screen 611 as depicted in the right of FIG. 6 is displayed. In the example of FIG. 6, a grouping button 612 and selection columns (selection columns 613 to 617) for respective grouping candidates are provided in the tuning screen 611. Compared with the tuning screen 601, the selection column 613 that “running cost” is excluded from the selection column 603 is displayed on the tuning screen 611, and a selection column 617 is newly provided for “running cost”. Incidentally, in this embodiment, the unification of the feature expressions (e.g. “manufacturing cost” in the selection column 603 and “manufacturing expense” in the selection column 606) included in different grouping candidates is not designated.

Moreover, in this embodiment, the grouping work support processing apparatus 1 judges whether or not the grouping candidate in the work satisfies a predetermined condition, and when it is judged that the grouping candidate satisfies the predetermined condition, the grouping work support processing apparatus 1 notifies the user to that effect. Here, the predetermined condition is a condition of whether or not it is ensured that an order of the grouping candidate in the work is equal to or higher than an order previously set by the user in a case where all of the grouping candidates are ordered. This is because it is possible to carry out the analysis according to the user's intension, even if the grouping work for the grouping candidate in the present work is stopped at that time, for example, when it is ensured that the order of the grouping candidate in the work is equal to or higher than the predetermined order.

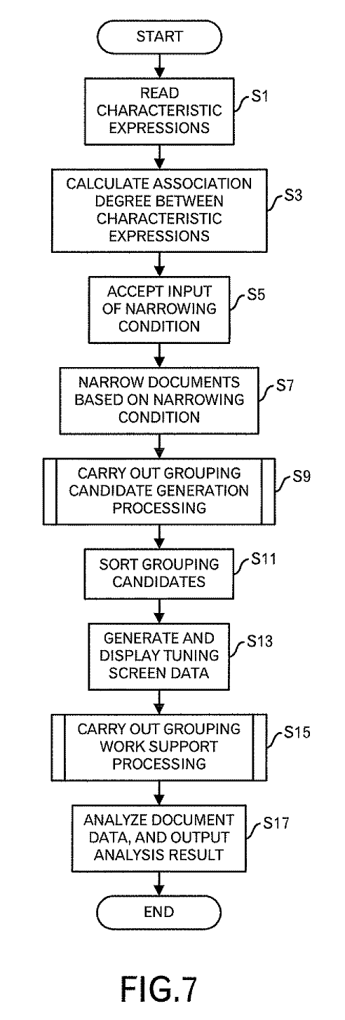

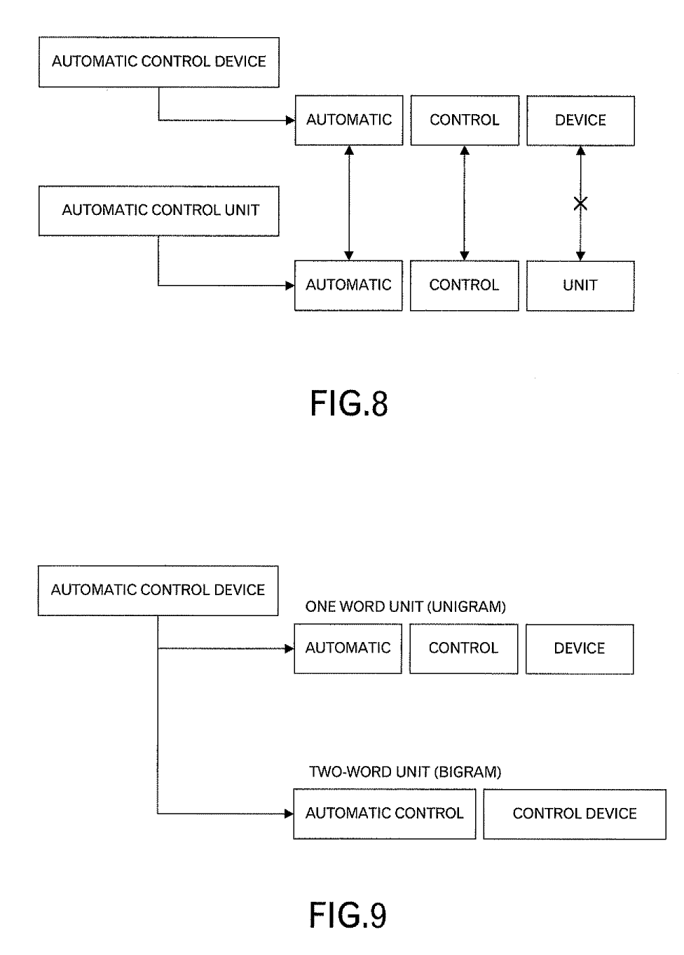

Next, the specific processing flow of the grouping work support processing apparatus 1 in this embodiment will be explained by using FIGS. 7 to 25. FIG. 7 depicts an entire processing flow executed by the grouping work support processing apparatus 1. First, the user instructs an analysis start to the grouping work support processing apparatus 1, and the grouping work support processing apparatus 1 accepts the analysis start instruction from the user. Then, the feature expression extraction unit 12 of the grouping work support processing apparatus 1 extracts feature expressions from the document DB 11, and temporarily stores them into a storage device (FIG. 7: step S1). Here, the feature expression includes bibliographic information (e.g. in the patent document, an applicant, inventor and the like), and words and phrases (e.g. in the patent document, words and phrases representing an object of the invention, or a target of the invention) extracted by any information extraction technique. Incidentally, the processing to extract the feature expression is not changed from the conventional processing. Therefore, further explanation is omitted. Then, the association degree calculator 13 of the grouping work support processing apparatus 1 calculates the association degrees between the feature expressions stored in the storage device to generate the association degree table and store this table into the association degree table storage 14 (step S3). In this embodiment, as an index representing the association degree between the feature expressions, a matching degree between words in the feature expressions is used. In the following, the details of the processing to calculate the association degree between the feature expressions will be explained by using FIGS. 8 and 9.

First, the association degree calculator 13 registers the feature expressions stored in the storage device into the line and column of the association degree table. Then, for example, as depicted by FIG. 8, the association degree calculator 13 respectively decomposes two feature expressions to be processed into words, and counts the number of matching words. Incidentally, it is preferable that the plural form is converted into the singular form and the conjugated form is converted into the normal form after the decomposition in order to appropriately compare the words. FIG. 8 depicts an example that an association degree between “automatic control device” and “automatic control unit” is calculated, and the number of matching words (i.e. “automatic” and “control”) is “2”. Then, the association degree calculator 13 divides the number (“2” in the example of FIG. 8) of matching words by the number (“3” in the example of FIG. 8) of words after the decomposition to calculate the matching degree and store, as the association degree, the matching degree into the association degree table. Incidentally, the number of words after the decomposition may be different from each other. Therefore, the greater value of the numbers of words after the decomposition may be adopted in such a case. Such a processing is carried out for each combination. Incidentally, as depicted in FIG. 9, the feature expression can be decomposed by one word unit, and can be decomposed by two-word unit. Moreover, the feature expression can be decomposed by three-word unit or more. Furthermore, the decomposition by one word unit and the decomposition by two-word unit can be combined. Incidentally, the index representing the association degree between the feature expressions is not limited to the matching degree between words, and the similarity degree based on, for example, the thesaurus may be used as the index.

In addition, the document narrowing unit 15 of the grouping work support processing apparatus 1 accepts an input of a narrowing condition from the user (step S5). For example, when the tendency of the applicants whose number of patent applications is large is analyzed, it is effective that the analysis is carried out after narrowing to the document data relating to the applicants whose number of patent applications is large. Therefore, in this embodiment, it is assumed that the user inputs the narrowing condition according to the intension of the analysis. Incidentally, the international patent classification (IPC) and/or the filing date or term may be adopted as the narrowing condition. Then, the document narrowing unit 15 narrows the document data based on the narrowing condition from the user, and stores the document data after the narrowing into the storage device (step S7).

Then, the grouping candidate generator 16 of the grouping work support processing apparatus 1 carries out a grouping candidate generation processing based on the document data after the narrowing, which is stored in the storage device, and the association degree table stored in the association degree table storage (step S9).

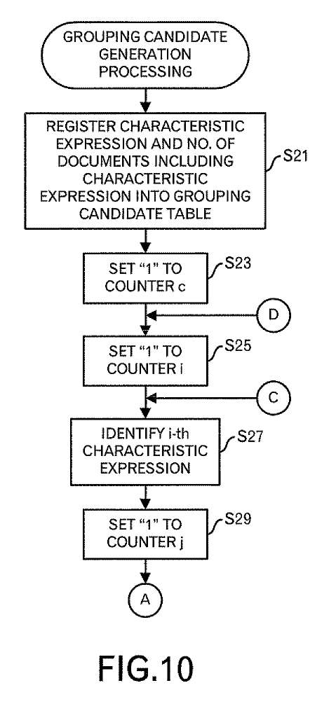

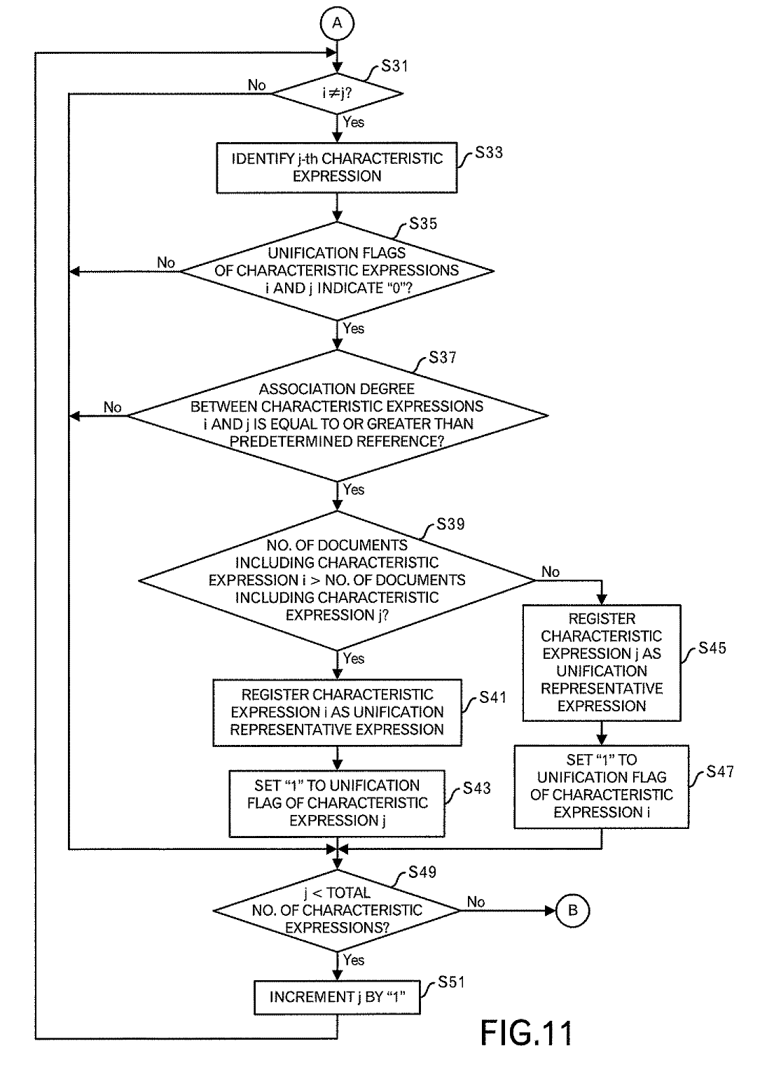

The grouping candidate generation processing will be explained by using FIGS. 10 to 12. First, the grouping candidate generator 16 extracts feature expressions from the document data after the narrowing, which is stored in the storage device, and registers sets of the feature expression and the number of documents including such a feature expression into the grouping candidate table (FIG. 10: step S21). Namely, they are respectively registered into the column of the feature expression and the column of the number of documents in the grouping candidate table. Then, the grouping candidate generator 16 sets “1” to a counter c (step S23). In addition, the grouping candidate generator 16 sets “1” to a counter i (step S25). Then, the grouping candidate generator 16 identifies the i-th feature expression (in the following, called feature expression [i]) in the grouping candidate table (step S27). In addition, the grouping candidate generator 16 sets “1” to a counter j (step S29). After that, the processing shifts to a processing of a step S31 in FIG. 11 through a terminal A.

Shifting to the explanation of FIG. 11, after the terminal A, the grouping candidate generator 16 judges whether or not the value of the counter i is different from the value of the counter j (i≠j) (FIG. 11: step S31). When the value of the counter i is identical with the value of the counter j (step S31: No route), the processing shifts to a processing of a step S49.

On the other hand, when it is judged that the value of the counter i is different from the value of the counter j (step S31: Yes route), the grouping candidate generator 16 identifies the j-th feature expression (in the following, called the feature expression [j]) in the grouping candidate table (step S33). Then, the grouping candidate generator 16 refers to the association degree table to judge whether or not “0” are respectively set to the unification flags of the feature expression [i] and feature expression [j] (step S35). When “1” is set to either the unification flag of the feature expression [i] or the unification flag of the feature expression [j] (step S35: No route), the processing shifts to the processing of the step S49.

On the other hand, when it is judged that “0” is respectively set to the unification flags of the feature expression [i] and the feature expression [j] (step S35: Yes route), the grouping candidate generator 16 refers to the association table to judge whether or not the association degree between the feature expression [i] and the feature expression [j] is equal to or greater than a predetermined reference (step S37). When it is judged that the association degree between the feature expression [i] and the feature expression [j] is less than the predetermined reference (step S37: No route), the processing shifts to the processing of the step S49.

On the other hand, when it is judged that the association degree between the feature expression [i] and the feature expression [j] is equal to or greater than the predetermined reference (step S37: Yes route), the grouping candidate generator 16 refers to the grouping candidate table to judge whether or not the number of documents relating to the feature expression [i] is greater than the number of documents relating to the feature expression [j] (step S39). When it is judged that the number of documents relating to the feature expression [i] is greater than the number of documents relating to the feature expression [j] (step S39: Yes route), the grouping candidate generator 16 registers the feature expression [i], as a unification representative expression, into the column of the grouping candidate in the lines of the feature expression [i] and the feature expression [j], in the grouping candidate table (step S41). In addition, the grouping candidate generator 16 sets “1” to the columns of the unification flags relating to the feature expression [j] in the association degree table (step S43). Namely, it indicates that it is expected that the feature expression [j] is unified to another feature expression. After that, the processing shifts to the processing of the step S49.

On the other hand, when it is judged that the number of documents relating to the feature expression [i] is equal to or less than the number of documents relating to the feature expression [j] (step S39: No route), the grouping candidate generator 16 registers the feature expression [j], as a unification representative expression, into the column of the grouping candidate in the lines of the feature expression [i] and the feature expression [j], in the grouping candidate table (step S45). In addition, the grouping candidate generator 16 sets “1” to the column of the unification flag relating to the feature expression [i] in the association degree table (step S47). That is, it shows that it is expected that the feature expression [i] is unified to an other feature expression. After that, the processing shifts to the processing of the step S49.

Shifting to the processing of the step S49, the grouping candidate generator 16 judges whether or not the value of the counter j is less than the total number of feature expressions registered in the grouping candidate table (step S49). When it is judged that the value of the counter j is less than the total number of feature expressions registered in the grouping candidate table, the grouping candidate generator 16 increments the value of the counter j by “1” (step S51), and the processing returns to the processing of the step S31 to repeat the aforementioned processing.

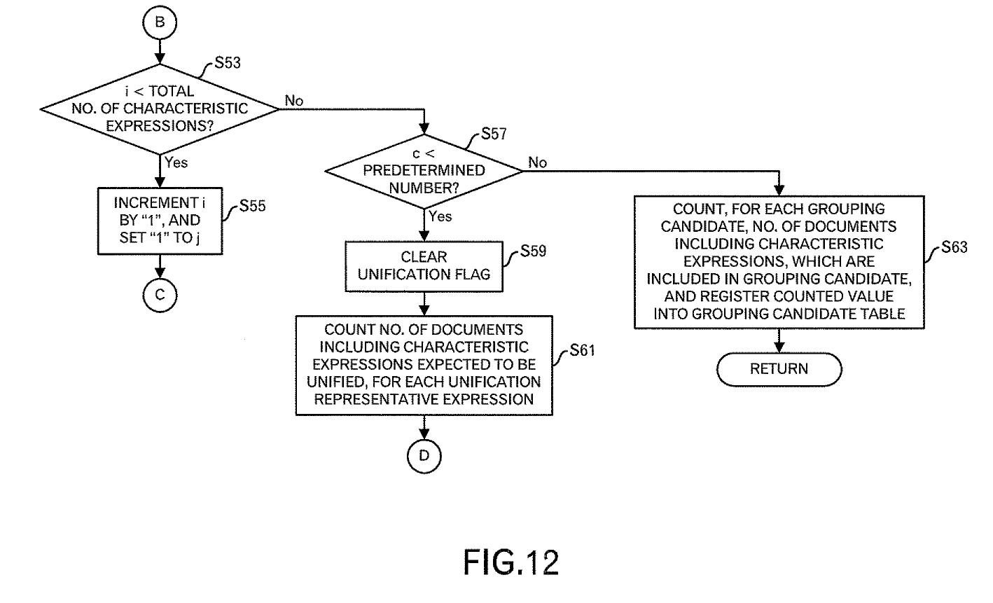

On the other hand, when the value of the counter j is equal to or greater than the total number of feature expressions registered in the grouping candidate table (step S49: No route), the processing shifts to a processing of a step S53 in FIG. 12 through a terminal B.

Shifting to the explanation of FIG. 12, after the terminal B, the grouping candidate generator 16 judges whether or not the value of the counter i is less than the total number of feature expressions registered in the grouping candidate table (FIG. 12: step S53). When it is judged that the value of the counter i is less than the total number of feature expressions registered in the grouping candidate table (step S53: Yes route), the grouping candidate generator 16 increments the value of the counter i by “1” and sets “1” to the counter j (step S55). After that, through a terminal C, the processing returns to the processing of the step S27 in FIG. 10 to repeat the aforementioned processing.

On the other hand, when it is judged that the value of the counter i is equal to or greater than the total number of feature expressions registered in the grouping candidate table (step S53: No route), the grouping candidate generator 16 judges whether or not the value of the counter c is less than a predetermined number (step S57). When it is judged that the value of the counter c is less than the predetermined number (step S57: Yes route), the grouping candidate generator 16 clears (i.e. sets “0” to) the unification flag in the association degree table (step S59). In addition, the grouping candidate generator 16 counts, for each unification representative expression, the number of documents including the feature expressions, which is expected to be unified to the unification representative expression, and stores the values into the storage device (step S61). After that, through a terminal D, the processing returns to the processing of the step S25 in FIG. 10 to repeat the aforementioned processing.

On the other hand, when it is judged that the value of the counter c is equal to or greater than the predetermined number (step S57: No route), the grouping candidate generator 16 counts, for each grouping candidate, the number of documents relating to the feature expressions included in the grouping candidate, and registers the counted value in the column of the number of documents relating to the grouping candidate in the grouping candidate table (step S63). Then, the grouping candidate generation processing is completed, and the processing returns to the original processing. Incidentally, the generated grouping candidate table is stored into the grouping candidate storage 17.

By carrying out the aforementioned processing, the grouping candidate table as depicted in FIG. 4 can be generated. Incidentally, by using the counter c, the processing from the step S25 to the step S61 is repeated the predetermined number of times. Accordingly, the stepwise grouping such as from “manufacturing cost” through “device cost” to “cost” can be realized.

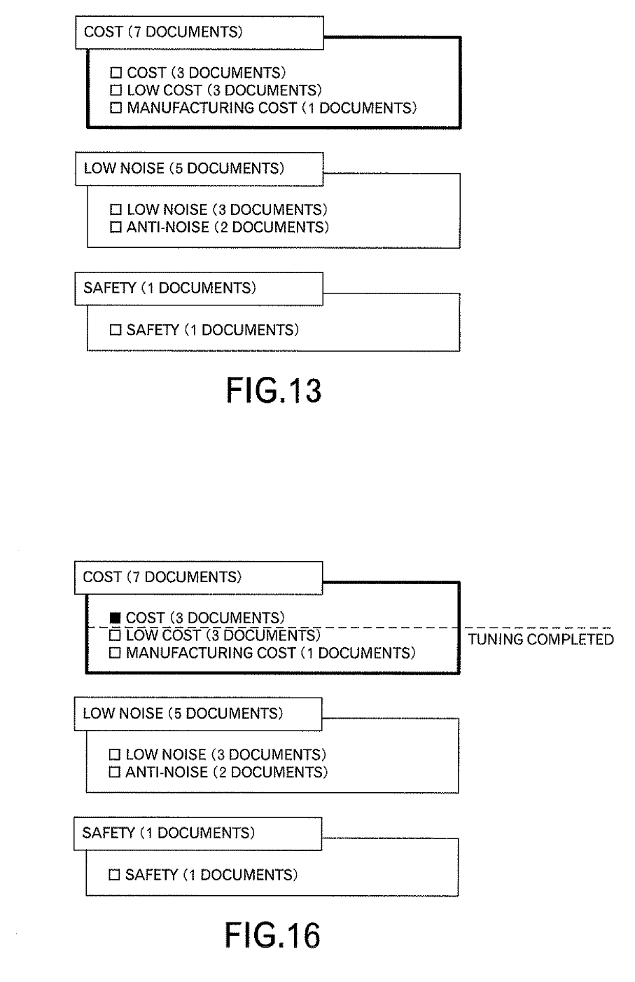

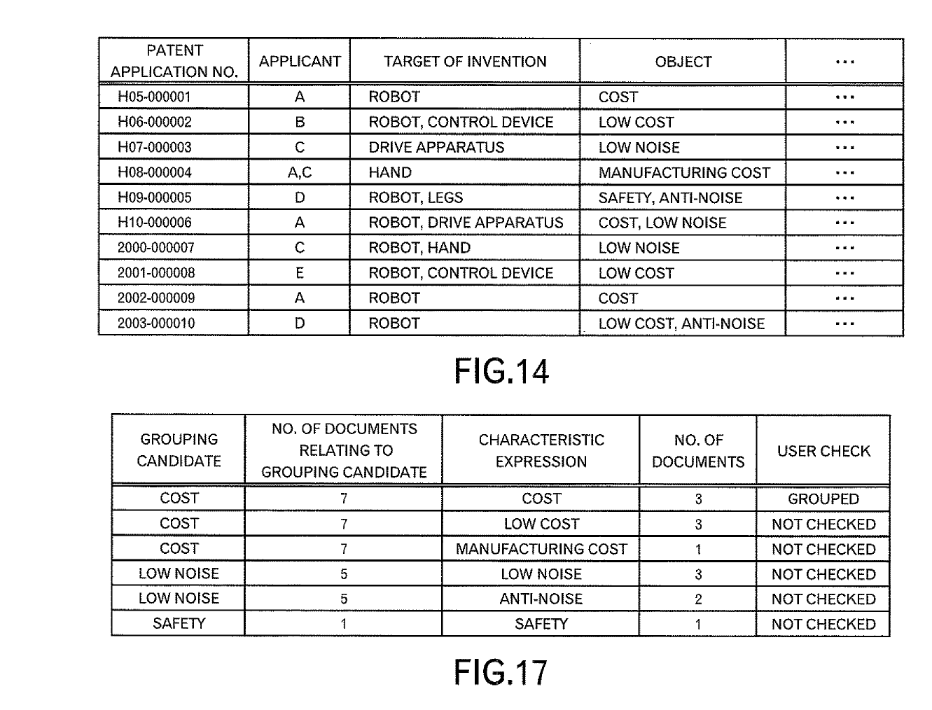

Returning to the explanation of FIG. 7, the grouping candidate generator 16 sorts data registered in the grouping candidate table in a descending order of the number of documents relating to the grouping candidate for each grouping candidate (FIG. 7: step S11). Then, the output unit 18 of the grouping work support processing apparatus 1 generates a tuning screen data based on the grouping candidate table, and displays the tuning screen on a display device or the like (step S13). For example, the tuning screen as depicted in FIG. 13 is displayed. Incidentally, data as depicted in FIG. 14 is stored in the document DB 11. In the example of FIG. 13, a selection column for each grouping candidate (“cost”, “low noise”, “safety”) is provided, and the screen indicates a grouping instruction can be inputted to a bold selection column (e.g. the selection column of “cost”). Incidentally, in this embodiment, it is assumed that the tuning screen that the input for the selection column of the grouping candidate, in which the number of documents relating to the grouping candidate is the maximum, is enabled, are presented to the user at the step S11. In addition, although it is not depicted in FIG. 13, a grouping button as depicted in FIG. 6 is provided. After that, the grouping instruction input unit 19 and the grouping work support processor 20 of the grouping work support processing apparatus 1 carry out a grouping work support processing in response to the grouping instruction from the user (step S15). Incidentally, in the grouping work support processing, it is judged in response to the grouping instruction from the user, whether or not the grouping candidate in the work satisfies a condition of whether or not it is ensured that an order of the grouping candidate in the work is equal to or higher than a predetermined order, and when the grouping candidate in the work satisfies such a condition, it is notified to the user. Incidentally, the predetermined order is previously set by the user, and in the following, the explanation will be carried out on the assumption that the predetermined order is “n”.

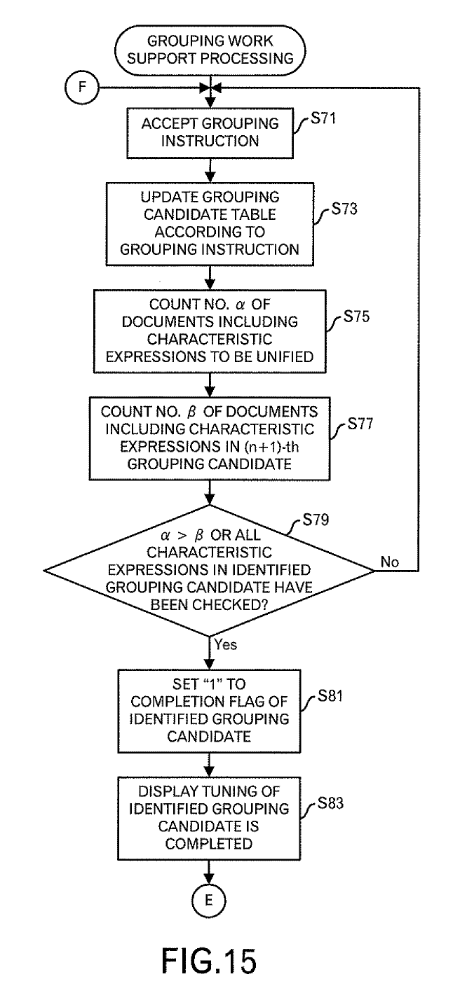

The grouping work support processing will be explained by using FIGS. 15 to 21. Incidentally, at the beginning of the grouping work support processing, the grouping completion flag table in which “0” is set to all of the completion flags is stored in the grouping candidate storage 17. For example, the user designates the feature expression to be unified or the feature expression to be excluded from the grouping candidates in the tuning screen (FIG. 13), and clicks the grouping button (not depicted). Incidentally, the designation of the feature expression to be unified or feature expression to be excluded from the grouping candidates is made in a designation column corresponding to each feature expression as depicted in FIG. 6. Then, the grouping instruction input unit 19 accepts an input of a grouping instruction including the designation of the feature expression to be unified or the feature expression to be excluded from the grouping candidates (FIG. 15: step S71). Then, the grouping work support processor 20 updates the column of the user check in the grouping candidate table according to the grouping instruction (step S73). In addition, the grouping work support processor 20 identifies the grouping candidate relating to the grouping instruction. Then, the grouping work support processor 20 counts the number of documents including the feature expressions to be unified, which are explicitly or implicitly designated in the grouping instruction, and stores the counted value as the number a of documents into the storage device (step S75). Moreover, the grouping work support processor 20 counts the number of documents including the feature expressions in the (n+1)-th grouping candidate, and stores the counted value as the number β of documents into the storage device (step S77).

Then, the grouping work support processor 20 judges whether or not the number α of documents is greater than the number β of documents or all of the feature expressions in the identified grouping candidate have been checked (step S79). When the number α of documents is equal to or less than the number β of documents and all of the feature expressions in the identified grouping candidate have not been checked (step S79: No route), the processing returns to the processing of the step S71. Then, the input of the next grouping instruction is awaited.

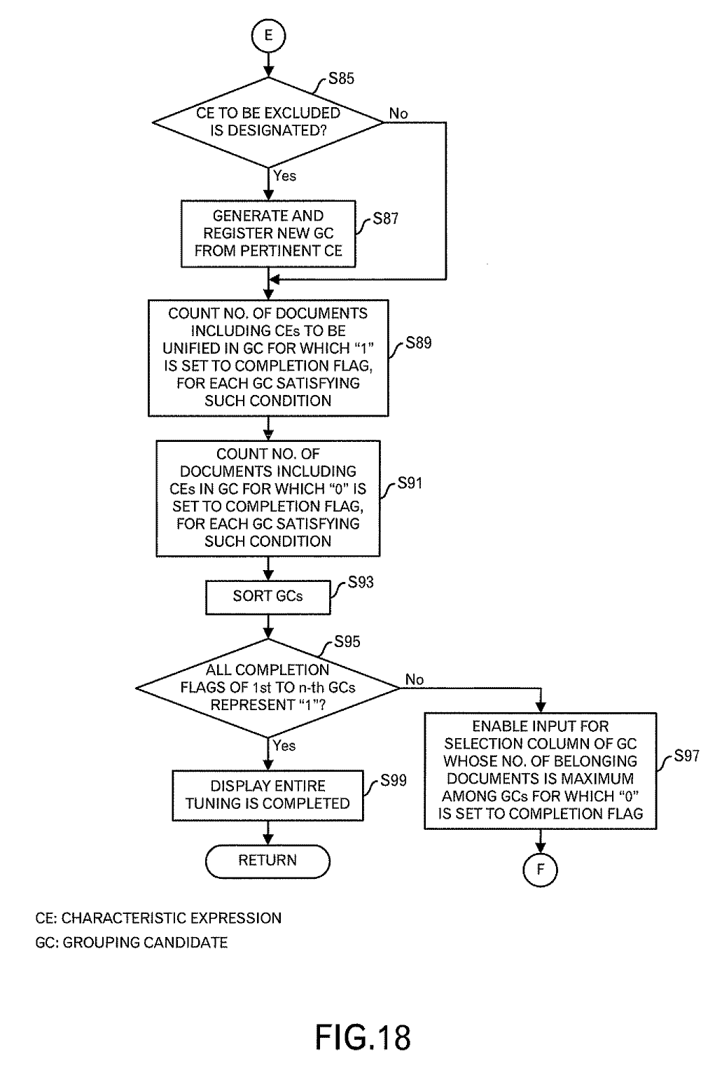

On the other hand, when the number α of documents is greater than the number β of documents or all of the feature expressions in the identified grouping candidate are objects of the unification (step S79: Yes route), the grouping work support processor 20 sets “1” to the completion flag of the identified grouping candidate in the grouping completion flag table (step S81). In addition, the grouping work support processor 20 displays to the effect that the tuning of the identified grouping candidate is completed on the tuning screen (step S83). For example, the tuning screen as depicted in FIG. 16 is displayed on the display device. FIG. 16 depicts an example of a case where “cost (3 documents)” is designated as the feature expression to be unified on the tuning screen as depicted in FIG. 13. Incidentally, it is assumed that “2” is set to “n”. In this case, data as depicted in FIG. 17 is stored in the grouping candidate table. In a state as depicted in FIG. 16, when the steps S75 and S77 are executed, the number α of documents becomes “3” (i.e. the number of documents including the feature expression “cost” to be unified in the grouping candidate “cost” is “3” (including Patent Applications Nos. H05-000001, H10-000006 and 2002-000009)), and the number β of documents becomes “1” (i.e. the number of documents including the feature expression “safety” in the third grouping candidate “safety” is “1” (including Patent Application No. H09-000005). That is, because α>β is satisfied and it is ensured that the grouping candidate “cost” is ranked equal to or higher than the second order, it is displayed that the tuning for the grouping candidate “cost” is completed as depicted in FIG. 16. After that, the processing shifts to a processing of a step S85 in FIG. 18 through a terminal E.

Shifting to the explanation of FIG. 18, after the terminal E, the grouping work support processor 20 judges whether or not the grouping instruction includes the designation of the feature expression to be excluded (FIG. 18: step S85). When the grouping instruction includes the designation of the feature expression to be excluded (step S85: Yes route), the grouping work support processor 20 generates a new grouping candidate from the pertinent feature expressions, and registers the generated data into the grouping candidate table (step S87). After that, the processing shifts to a processing of a step S89.

On the other hand, when the grouping instruction does not include the designation of the feature expression to be excluded (step S85: No route), the processing skips the processing of the step S87 to shift to the processing of the step S89.

Then, the grouping work support processor 20 counts the number of documents including the feature expression to be unified in the grouping candidate for which “1” is set to the completion flag in the grouping completion flag table for each grouping candidate satisfying such a condition, and stores the counted value into the storage device (step S89). In addition, the grouping work support processor 20 counts the number of documents including the feature expressions in the grouping candidate for which “0” is set to the completion flag in the grouping completion flag table for each grouping candidate satisfying such a condition, and stores the counted value into the storage device (step S91).

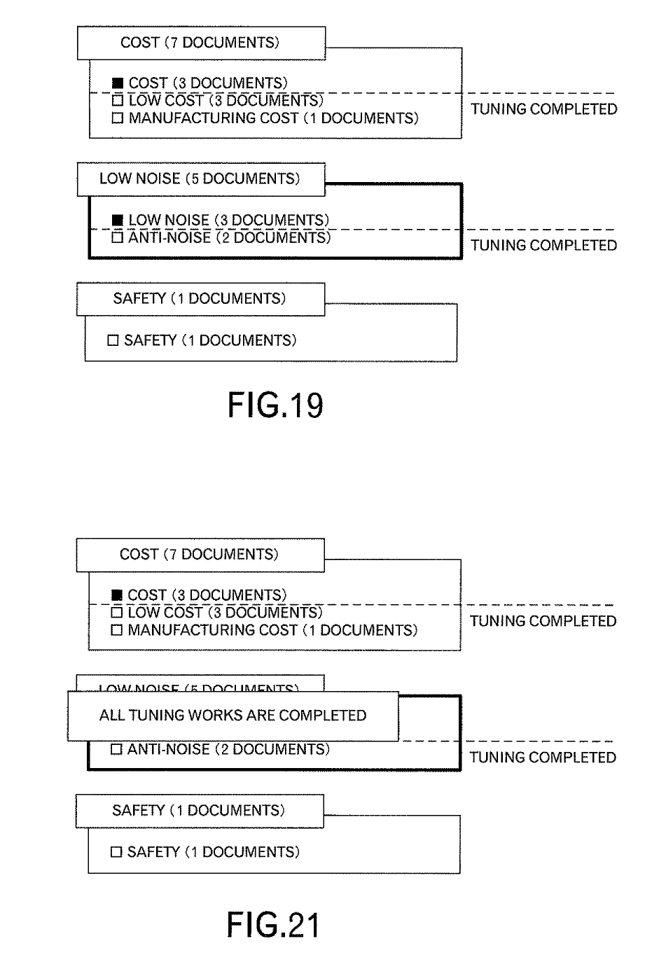

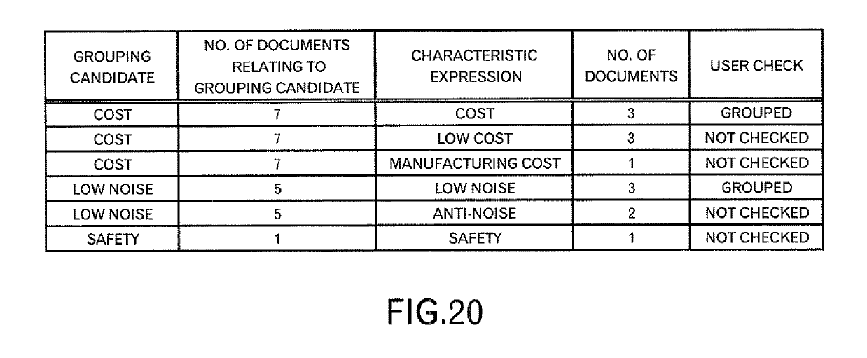

Then, the grouping work support processor 20 sorts the grouping candidates in a descending order of the counted values at the steps S89 and S91, and stores the sorting result into the storage device (step S93). Then, the grouping work support processor 20 judges whether or not “1” is set to all of the completion flags relating to the first to n-th grouping candidates (step S93). When “1” is not set to all of the completion flags relating to the first to n-th grouping candidates (step S95: No route), the grouping work support processor 20 enables the input for the selection column of the grouping candidate whose number of belonging documents is the maximum among the grouping candidates for which “0” is set to the completion flag (step S97). After that, the processing returns to the processing of the step S71 in FIG. 15 through a terminal F. Then, the grouping instruction input unit 19 waits the next grouping instruction. For example, in a state as depicted in FIG. 16, when the processing of the steps S89 to S93 is executed, “low noise” (5 documents, completion flag=“0”), “cost” (3 documents, completion flag=“1”) and “safety” (1 document, completion flag=“0”) are sorted in this order. Here, because “0” is set to the completion flag of “low noise” in the first order, the input for the selection column of “low noise” is enabled at the step S97, and the input of the next grouping instruction is waited. For example, when “low noise (3 documents)” is designated, as the feature expression to be unified, in the next grouping instruction and the processing of the steps S71 to S83 is executed, the tuning screen as depicted in FIG. 19 is displayed. Incidentally, data as depicted in FIG. 20 is stored into the grouping candidate table at this stage. In FIG. 19, because it is ensured that the grouping candidate “low noise” is ranked equal to or higher than the second order, the completion of tuning for the grouping candidate “low noise” is displayed.

On the other hand, when it is judged that “1” is set to all of the completion flags relating to the first to n-th grouping candidates (step S95: Yes route), the grouping work support processor 20 displays to the effect that the entire tuning is completed on the tuning screen (step S99). For example, in the state as depicted in FIG. 19, when the processing of the steps S89 to S93 is executed, “cost” (3 documents, completion flag=“1”), “low noise” (3 documents, completion flag=“1”) and “safety” (1 document, completion flag=“0”) are sorted in this order. Here, because “1” is set to the completion flags of “cost” and “low noise”, the tuning screen as depicted in FIG. 21 is displayed. Then, the grouping work support processing is completed and the processing returns to the original processing.

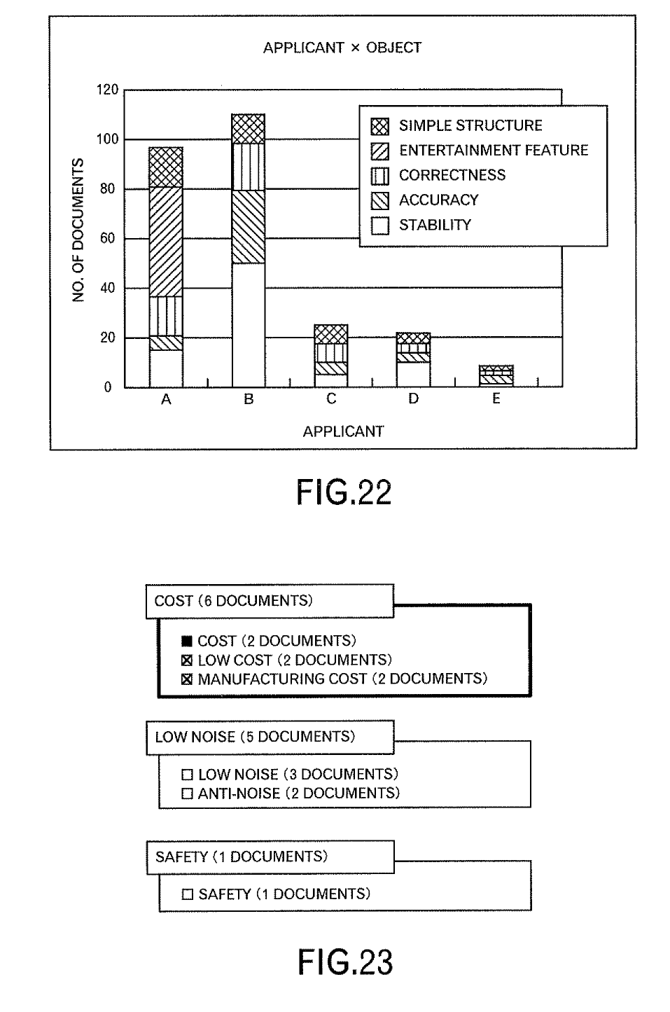

Returning to the explanation of FIG. 7, the analysis processor 21 of the grouping work support processing apparatus 1 analyzes the document data narrowed by the document narrowing unit 15 based on the grouping candidate table, and displays the analysis result on the display device (FIG. 7: step S17). For example, an analysis result screen as depicted in FIG. 22 is displayed. FIG. 22 depicts a graph representing, for each applicant, the number of objects.

By carrying out the aforementioned processing, when the user carries out the grouping work necessary for the analysis, the user can recognize the completion of the grouping work, and it becomes possible to eliminate an extra grouping work.

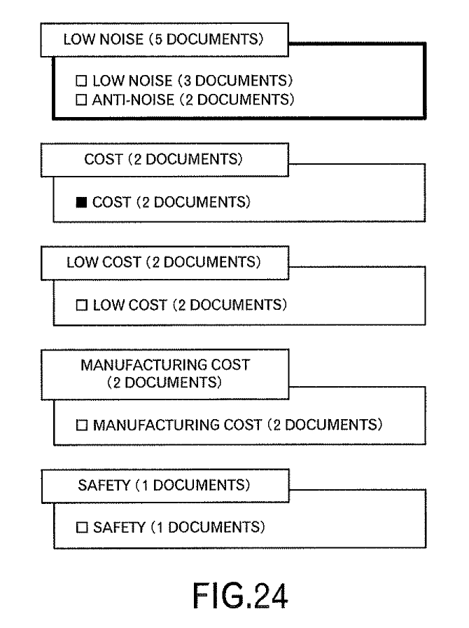

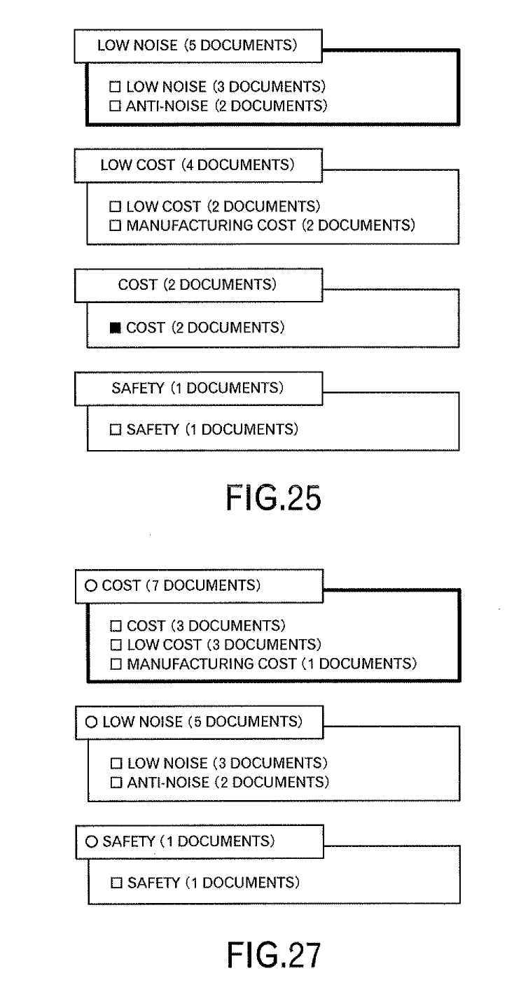

Incidentally, for example, as depicted in FIG. 23, when plural feature expressions (“low cost” and “manufacturing cost” in FIG. 23) are designated as the feature expressions to be excluded from the grouping candidate, the tuning screen as depicted in FIG. 24 is displayed. FIG. 24 depicts an example of a case where a new grouping candidate is generated at the step S87 for each pertinent feature expression. On the other hand, it may be judged based on the association degree between the pertinent feature expressions, whether or not the designated feature expression should be merged to another grouping candidate, and a grouping candidate may be newly generated when the association degree is equal to or greater than a predetermined reference. In this case, the tuning screen as depicted in FIG. 25 is displayed.

### Embodiment 2

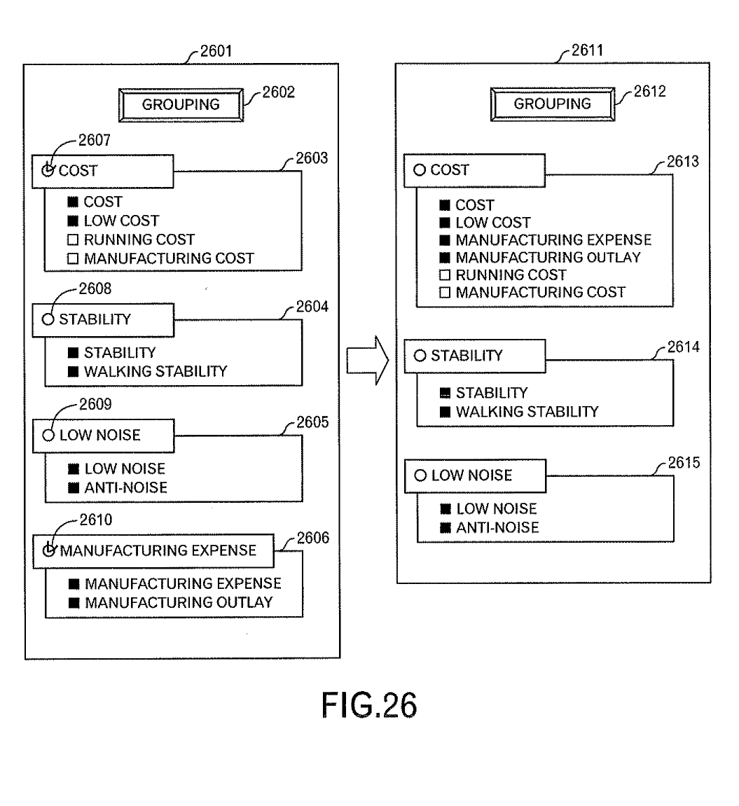

Next, a second embodiment of this technique will be explained by using FIGS. 26 to 34. Incidentally, the functional block diagram of the grouping work support processing apparatus 1 in the second embodiment is the same as that depicted in FIG. 1, basically. In the aforementioned first embodiment, it is assumed that the designation that the feature expressions included in the different grouping candidates are unified is not made. However, the user may like to unify the feature expressions included in the different grouping candidates. Then, in the second embodiment, the grouping work support processing apparatus 1 presents the user with a tuning screen 2601 as depicted in the left of FIG. 26.

In the example of FIG. 26, a grouping button 2602 and selection columns for respective grouping candidates (e.g. selection columns 2603 to 2606) are provided on the tuning screen 2601. Furthermore, the unification representative expression and feature expressions relating to the unification representative expression are displayed in each selection column, and furthermore, check boxes 2607 to 2610 to select the grouping candidate to be unified are provided. In addition, for each feature expression, a designation column to designate whether or not the feature expression should be unified or whether or not the feature expression should be excluded from the grouping candidate is provided in association with the corresponding feature expression. Then, when the user likes to unify the feature expressions included in the different grouping candidates, the user operates the mouse and/or keyboard to check at least two of the check boxes 2607 to 2610.

For example, in the tuning screen 2601, the check box 2607 for the selection column 2603 and the check box 2610 for the selection column 2606 are checked. In such a state, when the grouping button 2602 is clicked, the tuning screen 2611 as depicted in the right of FIG. 26 is displayed. In the example of FIG. 26, in the tuning screen 2611, a grouping button 2612 and selection columns for respective grouping candidates (selection columns 2613 to 2615) are provided. Compared with the tuning screen 2601, the selection column 2613 is provided on the tuning screen 2611 by unifying the selection columns 2603 and 2606. Thus, in the second embodiment, the grouping candidates whose check box was checked are unified to one grouping candidate.

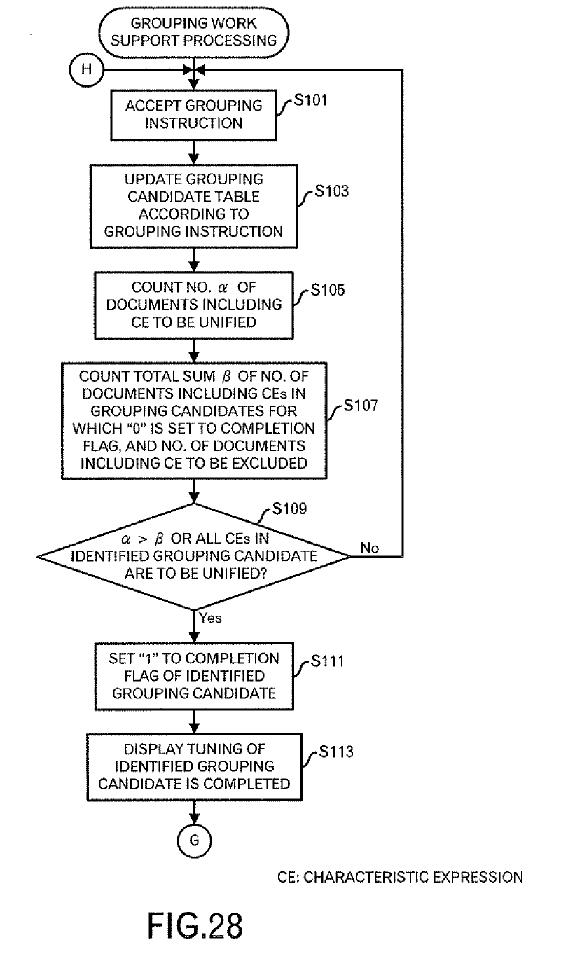

A specific processing flow by the grouping work support processing apparatus 1 in this embodiment will be explained by using FIGS. 27 to 34. Incidentally, the overall processing flow by the grouping work support processing apparatus 1 in this embodiment is the same as the processing flow depicted in FIG. 7, basically. However, in this embodiment, the grouping work support processing as depicted in FIGS. 28 to 31 is carried out at the step S15. In the following, the grouping work support processing in this embodiment will be explained. Incidentally, in this embodiment, it is assumed that the tuning screen data as depicted in FIG. 27 is generated at the step S13 and displayed on the display device. In the example of FIG. 27, the selection columns for respective grouping candidates (“cost”, “low noise” and “safety”) are provided, and the check box is also provided for the selection column. Incidentally, the bold selection column (the selection column for “cost”) indicates the input of the grouping instruction is enabled. In addition, although it is not depicted in FIG. 27, a grouping button as depicted in FIG. 26 is provided. Furthermore, at the beginning of the grouping work support processing, it is assumed that the grouping completion flag table in which “0” is set to all of the completion flags is stored in the grouping candidate storage 17. Moreover, data as depicted in FIG. 14 is stored in the document DB 11.

For example, the user designates the feature expressions to be unified or the feature expressions to be excluded from the grouping candidate in the tuning screen in FIG. 27, and when the user unifies two or more grouping candidates, the user checks the check boxes relating to the pertinent grouping candidates. Then, the user clicks the grouping button (not depicted). The grouping instruction input unit 19 accepts an input of the grouping instruction from the user (FIG. 28: step S101). Incidentally, the grouping instruction includes the designation of the feature expression to be unified, the designation of the feature expression to be excluded from the grouping candidate or the designation of the grouping candidates to be unified. Then, the grouping work support processor 20 updates the columns of the user checks in the grouping candidate table according to the grouping instruction (step S103). In addition, the grouping work support processor 20 identifies the grouping candidate relating to the grouping instruction. Then, the grouping work support processing 20 counts the number of documents including the feature expression, which is designated in the grouping instruction and is an object of the unification, and stores the counted value as the number α of documents into the storage device (step S105). Moreover, the grouping work support processing 20 counts the total sum β of the number of documents including the feature expression in the grouping candidate for which “0” is set to the completion flag, and the number of documents including the feature expression to be excluded (step S107). Incidentally, when the designation of the feature expression to be excluded is not included in the grouping instruction, the number of documents including the feature expression in the grouping candidates for which “0” is set to the completion flag is treated as the total sum β.

Then, the grouping work support processor 20 judges whether or not the number α of documents is greater than the total sum β, or whether or not all of the feature expressions in the identified grouping candidate are objects of the unification (step S109). When the number α of documents is equal to or less than the total sum α and all of the feature expressions in the identified grouping candidate are not objects of the unification (step S109: No route), the processing returns to the processing of the step S101. Then, an input of the next grouping instruction is awaited.

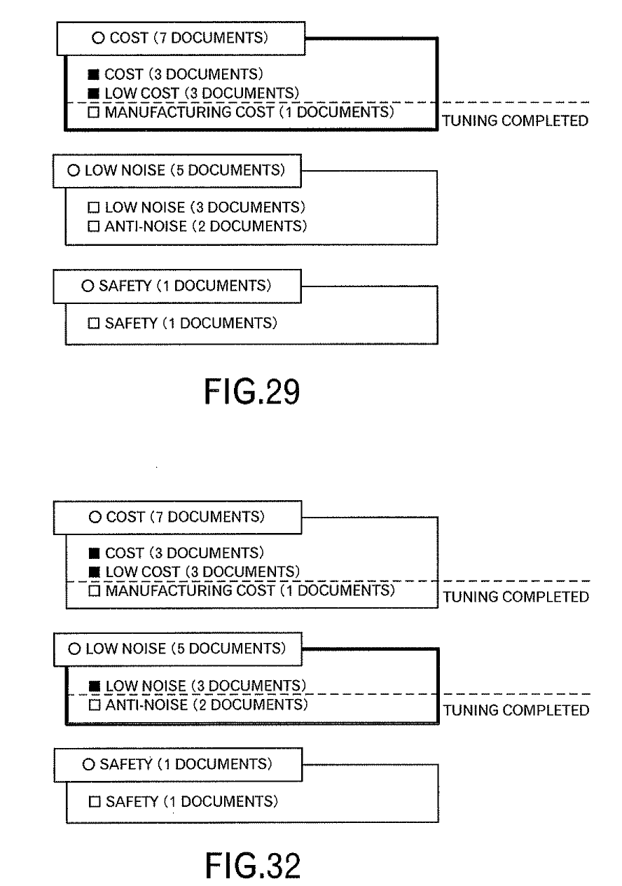

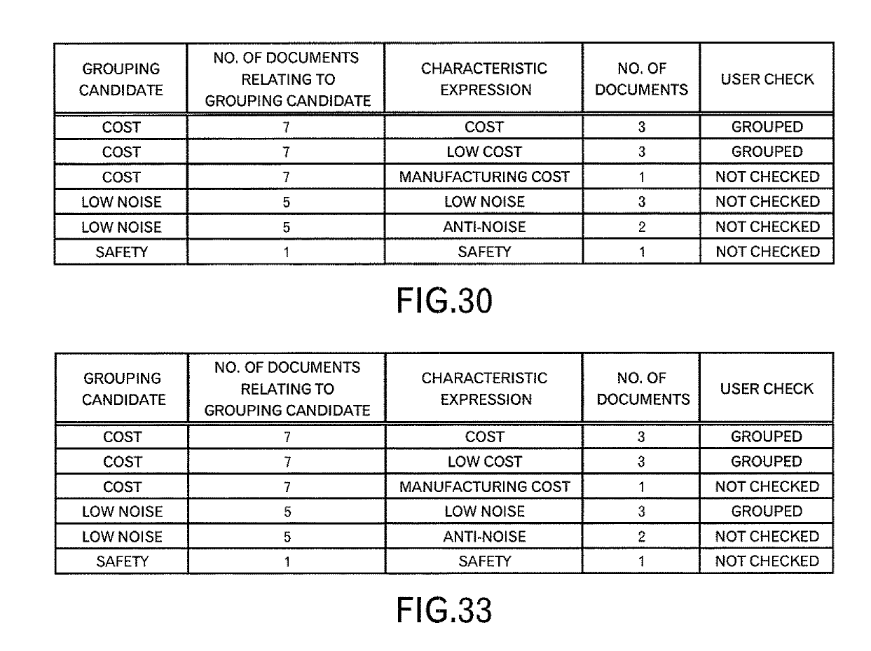

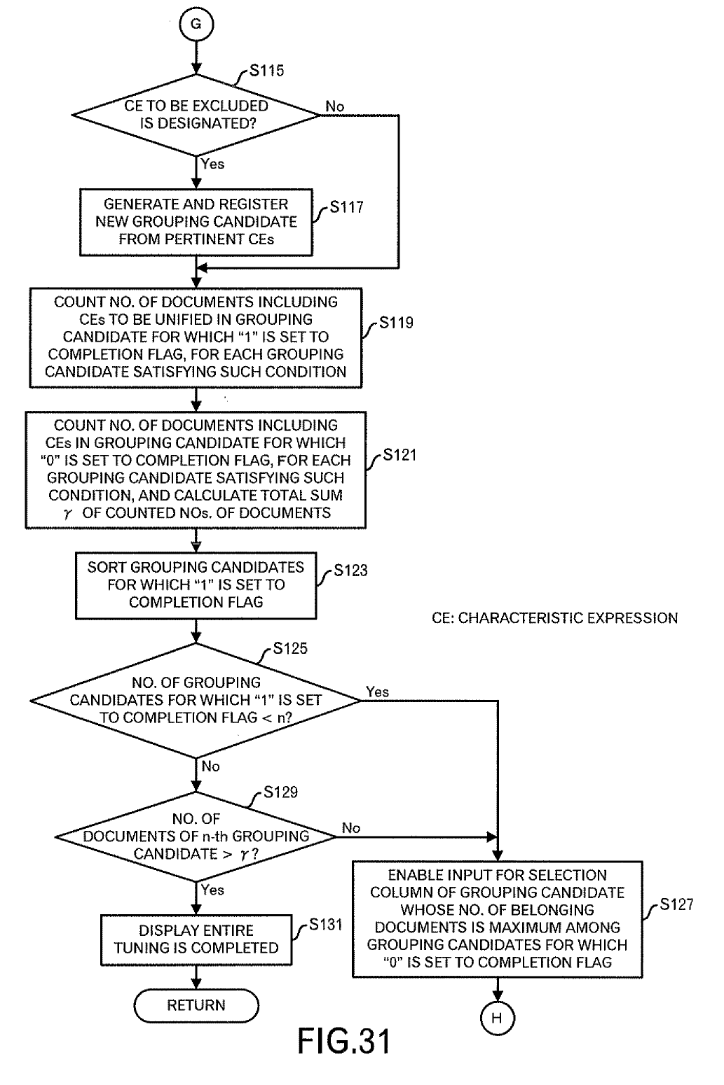

On the other hand, when the number α of documents is greater than the total sum β or all of the feature expressions in the identified grouping candidate are objects of the unification (step S109: Yes route), the grouping work support processor 20 sets “1” to the completion flag relating to the identified grouping candidate in the grouping completion flag table (step S111). In addition, the grouping work support processor 20 displays to the effect that the tuning of the identified grouping candidate is completed, on the tuning screen (step S113). For example, the tuning screen as depicted in FIG. 29 is displayed on the display screen. FIG. 29 depicts an example of a case where “cost (3 documents)” and “low cost (3 documents)” are designated as the feature expressions to be unified on the tuning screen as depicted in FIG. 27. Incidentally, n=2 is assumed. In this case, data as depicted in FIG. 30 is stored in the grouping candidate table. In a state as depicted in FIG. 29, when the steps 105 and S107 are executed, the number α of documents is “6” (i.e. the number of documents (Patent Application Nos. H05-000001, H06-000002, H10-000006, 2001-000008, 2002-000009 and 2003-000010) including the feature expressions “cost” and “low cost” to be unified in the grouping candidate “cost”), and the total sum β is “5” (i.e. the number of documents (Patent Application Nos. H07-000003, H09-000005, H10-000006, 2000-000007 and 2003-000010) including the feature expression “low noise”, “anti-noise” and “safety” in the grouping candidates “low noise” and “safety”, for which “0” is set to the completion flag). Namely, because α>β is satisfied and it is ensured that the grouping candidate “cost” is ranked equal to or higher than the second order, the completion of the tuning for the grouping candidate “cost” is displayed as depicted in FIG. 29. After that, the processing shifts to a processing of a step S115 in FIG. 31 through a terminal G.

Shifting to the explanation in FIG. 31, after the terminal G, the grouping work support processor 20 judges whether or not the grouping instruction includes the designation of the feature expression to be excluded (FIG. 31: step S115). When the grouping instruction includes the designation of the feature expression to be excluded (step S115: Yes route), the grouping work support processor 20 generates a new grouping candidate from the pertinent feature expressions, and registers the generated grouping candidate into the grouping candidate table (step S117). After that, the processing shifts to the processing of the step S119.

On the other hand, when the grouping instruction does not include the designation of the feature expression to be excluded (step S115: No route), the processing of the step S117 is skipped to shift to the processing of the step S119.

Then, the grouping work support processor 20 counts the number of documents including the feature expressions to be unified in the grouping candidate for which “1” is set to the completion flag in the grouping completion flag table, for each grouping candidate satisfying the aforementioned condition, and stores the counted value into the storage device (step S119). In addition, the grouping work support processor 20 counts the number of documents including the feature expression in the grouping candidate for which “0” is set to the completion flag in the grouping completion flag table, for each feature expression satisfying the aforementioned condition, calculates the total sum γ of the numbers of documents, and stores the obtained data into the storage device (step S121).

Then, the grouping work support processor 20 sorts the grouping candidates for which “1” is set to the completion flag in a descending order of the counted value obtained at the step S119, and stores the sorting result into the storage device (step S123). Then, the grouping work support processor 20 judges whether or not the number of grouping candidates for which “1” is set to the completion flag is less than “n” (step S125). When it is judged that the number of grouping candidates for which “1” is set to the completion flag is less than “n” (step S125: Yes route), the grouping work support processor 20 enables the input for the selection column of the grouping candidate whose number of documents is the maximum among the grouping candidates for which “0” is set to the completion flag (step S127). After that, the processing returns to the processing of the step S101 in FIG. 28. Then, the input of the next grouping instruction is awaited. For example, in the state as depicted in FIG. 29, because the number of grouping candidates for which “1” is set to the completion flag is “1”, the input for the selection column of “low noise” is enabled and the input of the next grouping instruction is awaited. For example, when “low noise (3 documents)” is designated as the feature expression to be unified in the next grouping instruction and the processing of the steps S101 to S113 is executed, a tuning screen as depicted in FIG. 32 is displayed. Incidentally, data as depicted in FIG. 33 is stored into the grouping candidate table at this stage. In FIG. 32, because it is ensured that the grouping candidate “low noise” is ranked equal to or higher than the second order, the completion of the tuning for the grouping candidate “low noise” is displayed.

On the other hand, when it is judged that the number of grouping candidates for which “1” is set to the completion flag is equal to or greater than “n” (step S125: No route), the grouping work support processor 20 judges based on the sorting result stored in the storage device, whether or not the number of documents relating to the n-th grouping candidate is greater than y (step S129). When the number of documents relating to the n-th grouping candidate is equal to or less than γ (step S129: No route), the processing shifts to the processing of the aforementioned step S127.

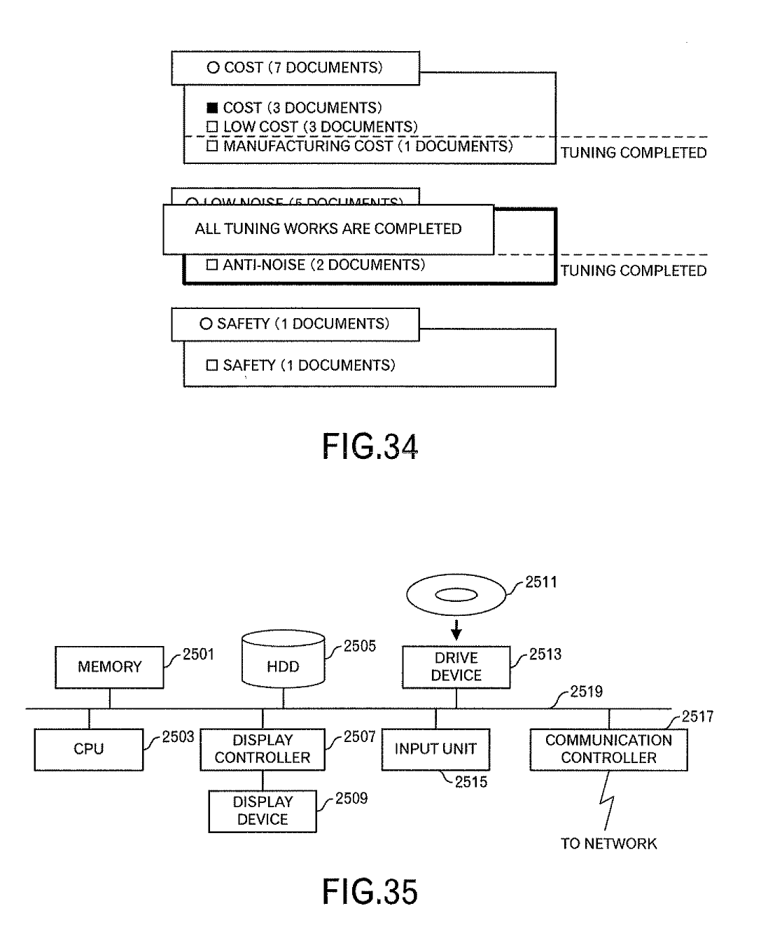

On the other hand, when it is judged that the number of documents relating to the n-th grouping candidate is greater than γ (step S129: Yes route), the grouping work support processor 20 displays to the effect that the entire tuning is completed on the tuning screen (step S131). For example, in the state as depicted in FIG. 32, when the processing of the steps S119 to S123, “cost” (6 documents, completion flag=1) and “low noise” (3 documents, completion flag=1) are sorted in this order, and γ becomes “1” (i.e. the number of documents (Patent Application No. H09-000005) including the feature expression “safety” in the grouping candidate “safety”). Here, because the number of documents including the feature expression to be unified in the second grouping candidate “low noise” is equal to or greater than γ, the tuning screen as depicted in FIG. 34 is displayed at the step S131. Then, the grouping work support processing is completed and returns to the original processing.

By carrying out the aforementioned processing, even in a case where the designation that the feature expressions included in the different grouping candidates are unified is made, the user can recognize the grouping work is completed, and it is possible to eliminate an extra grouping work.

Although the embodiments of this technique are explained above, this technique is not limited to these embodiments. For example, the functional block configuration explained above does not always correspond to the actual program module configuration. Furthermore, in the processing flow, the order of the processing can be exchanged even if the processing result does not change. Moreover, they may be executed in parallel.

Moreover, the aforementioned respective table formats are mere examples, and the table formats are not always limited to the aforementioned ones. Furthermore, the aforementioned screens are mere examples, and it is possible to adopt other screen configuration to display the same contents.

The aforementioned embodiments can be summarized into the following aspects.

A grouping work support processing method according to the embodiments includes: extracting a plurality of feature expressions from a plurality of documents, and categorizing the extracted feature expressions into a plurality of sets; presenting a user with at least one of the plurality of sets in a manner that the feature expressions included in the set can be recognized; accepting, from the user, a grouping instruction including designation of the feature expression to be unified among the feature expressions included in a specific set, and counting the number of documents including the feature expression to be unified, which is included in the grouping instruction, and storing the counted value as the first value; counting the number of documents including the feature expression included in a set that is other than the specific set and identified by at least one of a grouping mode and a grouping state, and storing the counted value as the second value, into the storage device; judging based on the first and second numbers of documents whether or not a predetermined condition is satisfied; upon detecting that it is judged that the predetermined condition is satisfied, notifying the user of completion of the designation the feature expression to be unified.

Thus, when the grouping work is carried out until the predetermined condition is satisfied, the completion of the grouping work is notified to the user at that time. Therefore, the user can recognize the grouping work is completed. For example, by setting the condition matching the object of the analysis, it is possible to omit the grouping work that does not influence the analysis result and to efficiently carry out the grouping work.

In addition, the aforementioned counting, as the second value, the number of documents may include counting, for each set other than the specific set, the number of documents as the second value. Then, the aforementioned judging may include: judging whether or not an order of the specific set, which is assigned based on the first value and the respective second values, among the plurality of sets, is equal to or higher than a predetermined order; and upon detecting that it is judged that the order of the specific set is equal to or higher than the predetermined order, judging that the predetermined condition is satisfied. For example, when the grouping of the feature expressions in the set is carried out for each set (i.e. for each grouping candidate), it is possible to judge, by carrying out such judgment, whether or not the predetermined condition is satisfied.

Furthermore, the aforementioned judging may include: judging whether or not the first value is greater than the second value; and upon detecting that it is judged that the first value is greater than the second value, judging that the predetermined condition is satisfied. In addition, the counting, as the second value, the number of documents may include upon detecting the a set for which designation of the feature expression is completed exists among the sets other than the specific set, counting, as the second value, the number of documents including the feature expressions, which are included in the sets for which designation of the feature expression is not completed. For example, even when the grouping of the feature expression included in a certain set and the feature expression included in another set is carried out, it is possible to judge whether or not the predetermined condition is satisfied.

Furthermore, the aforementioned counting, as the first value, the number of documents may include upon detecting that the grouping instruction includes designation of the feature expression to be excluded from the specific set, generating a new set by excluding the feature expression to be excluded from the specific set. Thus, it is possible to deal with a case where a certain feature expression is excluded from the set.

Moreover, the aforementioned categorizing may include accepting an input of a document narrowing condition from the user, carrying out narrowing of the documents according to the document narrowing condition, and extracting the feature expression from the documents after the narrowing. Thus, by carrying out the narrowing of the documents, it is possible to effectively carry out the analysis.

Furthermore, the aforementioned presenting the user with at least one of the plurality of sets may include counting the number of documents including the feature expression, which is included in the set, for each set, and preferentially presenting the user with the sets in a descending order of the number of documents. For example, because the set whose number of documents is greater largely influence the analysis result such as the graph or map, it is possible to carry out the much effective grouping work by preferentially presenting.

Moreover, the aforementioned grouping mode may be a mode ensuring that the respective sets up to the top predetermined order are not replaced with the sets whose order is lower than the top predetermined order, even when accepting the next grouping instruction, in a case where the grouping of the feature expressions included in the set is carried out for each set, or a mode ensuring that the respective sets up to the top predetermined order are not replaced with the sets whose order is lower than the top predetermined order, even when accepting the next grouping instruction, in a case where the grouping of the feature expression included in the set and the feature expression in another set is carried out.

Incidentally, it is possible to create a program causing a computer to execute the aforementioned method, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

In addition, the grouping work support processing apparatus 1 is a computer device as shown in FIG. 35. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 35. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the computer-readable removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in detail are realized.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A grouping work support processing method, comprising:
extracting a plurality of feature expressions from a plurality of documents, and categorizing the extracted feature expressions into a plurality of sets;
presenting a user with at least one of said plurality of sets in a manner that said feature expressions included in said set can be recognized;
accepting, from said user, a grouping instruction including designation of said feature expressions to be unified among said feature expressions included in a specific set, and counting, as a first value, a number of documents including said feature expressions to be unified, which is designated in said grouping instruction;
counting, as a second value, a number of documents including said feature expression included in a set that is other than said specific set and identified by at least one of a grouping mode and a grouping state;
judging based on said first and second values, whether or not a predetermined condition is satisfied; and
upon detecting that it is judged that said predetermined condition is satisfied, notify said user of completion of said designation of said feature expression to be unified.

2. The grouping work support processing method as set forth in claim 1, wherein said counting, as said second value, said number of documents comprises counting, for each said set other than said specific set, said second value, and
wherein said judging comprises:
judging whether or not an order of said specific set, which is assigned, among said plurality of sets, based on said first value and said respective second values, is equal to or higher than a predetermined order; and
upon detecting that it is judged that said order of said specific set is equal to or higher than a predetermined order, judging that said predetermined condition is satisfied.

3. The grouping work support processing method as set forth in claim 1, wherein said judging comprises:
judging whether or not said first value is greater than said second value; and
upon detecting that it is judged that said first value is greater than said second value, judging that said predetermined condition is satisfied.

4. The grouping work support processing method as set forth in claim 3, wherein said counting, as said second value, said number of documents comprises: upon detecting that a set for which designation of said feature expression is completed exists among said sets other than said specific set, counting, as said second value, a number of documents including said feature expressions, which are included in said sets for which designation of said feature expression is not completed.

5. The grouping work support processing method as set forth in claim 1, wherein said counting, as said first value, said number of documents comprises, upon detecting that said grouping instruction includes designation of said feature expression to be excluded from said specific set, generating a new set by excluding said feature expression to be excluded from said specific set.

6. The grouping work support processing method as set forth in claim 1, wherein said categorizing comprises accepting an input of a document narrowing condition from said user, carrying out narrowing of said documents according to said document narrowing condition, and extracting said feature expression from said documents after said narrowing.

7. The grouping work support processing method as set forth in claim 1, wherein said presenting comprises: counting, for each said set, a number of documents including said feature expressions, which are included in said set, and preferentially presenting said user with said sets in a descending order of the counted number of documents.

8. The grouping work support processing method as set forth in claim 1, wherein said grouping mode is a mode ensuring that said respective sets up to a top predetermined order are not replaced with said sets whose order is lower than said top predetermined order, even when accepting a next grouping instruction, in a case where grouping of said feature expressions included in said set is carried out for each said set, or a mode ensuring that said respective sets up to said top predetermined order are not replaced with said sets whose order is lower than said top predetermined order, even when accepting said next grouping instruction, in a case where grouping of said feature expressions included in one set and said feature expression in another set is carried out.

9. A computer-readable storage medium storing a program for causing a computer to execute a grouping work support process comprising:
extracting a plurality of feature expressions from a plurality of documents, and categorizing the extracted feature expressions into a plurality of sets;
presenting a user with at least one of said plurality of sets in a manner that said feature expressions included in said set can be recognized;
accepting, from said user, a grouping instruction including designation of said feature expressions to be unified among said feature expressions included in a specific set, and counting, as a first value, a number of documents including said feature expressions to be unified, which is designated in said grouping instruction;
counting, as a second value, a number of documents including said feature expression included in a set that is other than said specific set and identified by at least one of a grouping mode and a grouping state;
judging based on said first and second values, whether or not a predetermined condition is satisfied; and
upon detecting that it is judged that said predetermined condition is satisfied, notify said user of completion of said designation of said feature expression to be unified.

10. A grouping work support processing apparatus, comprising:
a storage device;
a unit that extracts a plurality of feature expressions from a plurality of documents, and categorizing the extracted feature expressions into a plurality of sets;
a unit that presents, via a display device, a user with at least one of said plurality of sets in a manner that said feature expressions included in said set can be recognized;
a unit that accepts, from said user, a grouping instruction including designation of said feature expressions to be unified among said feature expressions included in a specific set, and counts and stores into said storage device, as a first value, a number of documents including said feature expressions to be unified, which is designated in said grouping instruction;
a unit that counts and stores into said storage device, as a second value, a number of documents including said feature expression included in a set that is other than said specific set and identified by at least one of a grouping mode and a grouping state;
judging based on said first and second values, which are stored in said storage device, whether or not a predetermined condition is satisfied; and
upon detecting that it is judged that said predetermined condition is satisfied, notify said user of completion of said designation of said feature expression to be unified.
